(19) United States
(12) Patent Application Publication
(10) Pub. No.: US 2003/0081337 A1
(43) Pub. Date: May 1, 2003

(54) Method and apparatus for controlling write operation in a disk drive

(76) Inventor: Kazushi Tanimoto, Tokyo (JP)

Correspondence Address: PILLSBURY WINTHROP, LLP, P.O. BOX 10500, MCLEAN, VA, 22102, US

(21) Appl. No.: 10/234,718

(22) Filed: Sep. 5, 2002

(30) Foreign Application Priority Data
Oct. 31, 2001 (JP) 2001-335420
Apr. 3, 2002 (JP) 2002-101488

(51) Int. Cl. G11B 19/04; G11B 19/02

(52) U.S. Cl. 360/60; 360/69

(57) ABSTRACT

There is disclosed a disk drive which uses a magnetic disk medium and executes a non-normal write operation that a host system is not concerned with other than normal read/write operations that the host system is concerned with. This drive inhibits the non-normal write operation in a temperature environment not more than a low-temperature limit based on a temperature value from a temperature sensor at the time of executing the non-normal write operation.

### CROSS-REFERENCE TO RELATED APPLICATIONS

This application is based upon and claims the benefit of priority from the prior Japanese Patent Applications No. 2001-335420, filed Oct. 31, 2001; and No. 2002-101488, filed Apr. 3, 2002, the entire contents of both of which are incorporated herein by reference.

### BACKGROUND OF THE INVENTION

1. Field of the Invention

The present invention generally relates to the field of a disk drive which uses a magnetic disk medium, and more particularly to write operation control for a non-normal write operation other than a normal write operation.

2. Description of the Related Art

In general, a disk drive, such as a hard disk drive or a magneto-optical disk drive, magnetically records data on a magnetic disk medium (which may be simply referred to as a disk hereinafter) and reproduces recorded data on this disk by using a head.

Recent disk drives are used for various purposes such as external storage devices of, e.g., personal computers as well as data storage devices of various kinds of digital devices mounted in a digital TV or an automobile. Against such a background, with diversification of the environments in which the disk drives are used, demands for technical measures for the temperature environment in particular are increasing.

Usually, to assure constant reliability, the temperature range in the environment in which a disk drive normally operates is defined in the product specifications in advance. In the disk drive, the recording characteristics (write operation characteristic or magnetic recording characteristic) at a low temperature are particularly important for magnetically recording data on the disk.

In general, in the field of magnetic recording techniques, the coercive force of the disk becomes large with a reduction in temperature. Therefore, magnetic recording by flux reversal on the disk becomes difficult beyond the magnetic recording capability of the write head of the drive when the ambient environment of the disk drive enters an extremely low temperature state.

Therefore, in the temperature range as a product specification, specification of a temperature value of the operation limit on the low-temperature side is based on the recording characteristic for the write operation. Incidentally, in the read operation which reads data from the disk, the tolerance for operation on the low-temperature side is wide compared with the write operation. Further, the temperature value of the operating limit on the high-temperature side is determined as the read/write operation characteristic and the operating characteristics of the components of the disk drive.

In the disk drive, the temperature specification in read/write operations is based on the magnetic recording characteristic at a low temperature in particular. In a low-temperature environment which exceeds the tolerance of the temperature specification, the possibility that sufficient reliability for the recorded data not can be assured becomes high when a write operation which records data on the disk is executed.

As a countermeasure, there is proposed a prior art technique which monitors the temperature in the disk drive by using a temperature sensor and inhibits write operations when a low-temperature state exceeding the tolerance occurs (for example, see Jpn. Pat. Appln. KOKAI Publication No. 7-6560). With such a prior art technique, even if fluctuations in temperature falling below the low-temperature limit occur, it is possible to prevent user data of low reliability from being recorded on the disk.

Meanwhile, in the disk drive, there is executed a write operation (non-normal write operation) that does not concern host system (irrespective of the issue of a write command) other than the normal write operation. Specifically, this is the write operation when a read error is generated in a read operation. This non-normal write operation is the operation involved in alternative processing which changes a recording area (data track or data sector) on the disk when a read error occurs to another recording area. In the alternative processing, a write operation is executed which rewrites an address conversion table recorded on the disk. Further, the write operation which records or updates history information concerning operation history at the start-up of the disk drive is also a non-normal write operation which is irrelevant to the issue of a write command.

In the normal read/write operation, the host system is concerned. That is, in response to a read/write command from the host system, the disk drive executes a read/write operation. Therefore, in the environment where the disk drive is used, when the temperature becomes equal to or below a low-temperature limit, the host system can stop the issue of a write command and can issue only a read command.

However, in a non-normal write operation which is not the above-described normal operation, since the host system not can control it, the write operation is executed even in a temperature environment equal to or below the low-temperature limit. In such a write operation at a temperature equal to or below the low-temperature limit, data or history information which cannot assure sufficient reliability is recorded on the disk. Therefore, in the worst case, data or information recorded on the disk may be lost.

### BRIEF SUMMARY OF THE INVENTION

It is an object of the present invention to provide a disk drive which can improve the reliability of data recording on a disk by inhibiting a write operation that a host system is not concerned with (non-normal write operation) when the temperature state in the environment where the drive is used becomes equal to or below a low-temperature limit.

In accordance with one aspect of the present invention, there is provided a disk drive including facilities to inhibit write operation that the host system is not concerned with in a temperature environment equal to or lower than a low-temperature limit.

The disk drive comprises a read/write mechanism which executes a read operation and write operation of data with respect to a magnetic disk medium; a temperature sensor which detects temperature; and a controller which inhibits a non-normal write operation when a temperature value detected by the temperature sensor is not more than a stipulated value in a non-normal write operation to write data to the magnetic disk medium irrespective of a data write command supplied from the outside.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a primary part of a disk drive concerning embodiments of the present invention;

FIG. 2 is a view illustrating a temperature characteristic of read/write operation concerning a first embodiment;

FIG. 3 is a block diagram illustrating a modification concerning the first embodiment;

FIGS. 4 and 5 are flowcharts illustrating the procedure of write control in alternative processing concerning the first embodiment;

FIG. 6 is a flowchart illustrating the procedure of write control in the recording of history information concerning the first embodiment;

FIG. 7 is a flowchart concerning a second embodiment;

FIG. 8 is a flowchart concerning a third embodiment;

FIG. 9 is a flowchart concerning a fourth embodiment;

FIG. 10 is a flowchart concerning a fifth embodiment;

FIG. 11 is a flowchart concerning a sixth embodiment; and

FIG. 12 is a flowchart concerning a seventh embodiment.

### DETAILED DESCRIPTION OF THE INVENTION

The embodiment according to the present invention will now be described with reference to the accompanying drawings.

(Structure of Disk Drive)

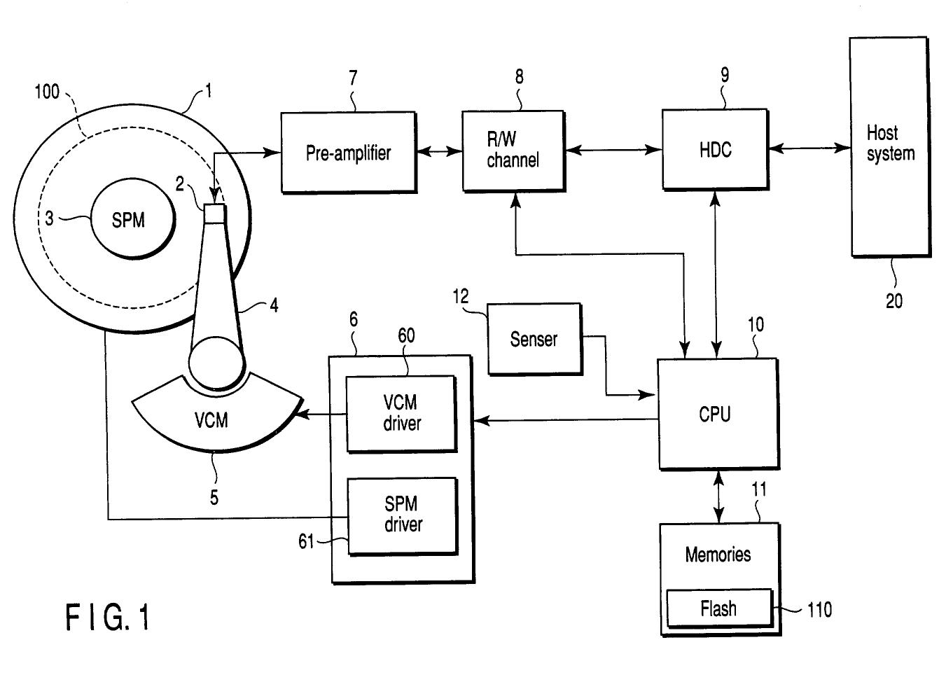

FIG. 1 is a block diagram showing a primary part of a disk drive in the embodiments.

As this disk drive, a hard disk drive (HDD) which uses a disk 1 as a magnetic recording medium is assumed.

This drive has a magnetic head 2 in order to perform read/write operations with respect to the disk 1. The disk 1 is fixed to a spindle motor (SPM) 3 and rotated at high speed. The magnetic head 2 is mounted on an actuator 4 driven by a voice coil motor (VCM) 5. To the VCM 5 is supplied a drive current by a VCM driver 60 included in a motor driver IC 6. The motor driver IC 6 includes a VCM driver 60 and an SPM driver 61 and is controlled by a CPU 10.

Here, the magnetic head 2 has a structure such that a read head for executing read operations and a write head for executing write operations are separated from each other and mounted on a slider. An actuator 4 is driven and controlled by a servo system which uses the CPU 10 as a main element, and positions the magnetic head 2 on the disk 1.

Besides such a head/disk assembly, the disk drive includes a circuit system having a preamplifier circuit 7, a R/W channel 8, a disk controller (HDC) 9, a microprocessor (CPU) 10, and a memory 11.

The preamplifier circuit 7 has a read amplifier and a write amplifier. The read amplifier amplifies a read signal output from the read head. The write amplifier converts a write data signal output from the R/W channel 8 into a write current signal, and supplies it to the write head. The R/W channel 8 is a signal processing IC which processes the read/write data signal (including a servo data signal). The HDC 9 has an interface function with the drive and the host system 20 (for example, a personal computer or a digital device).

The CPU 10 is the main control device of the drive. The CPU 10 executes servo system control operation, normal read/write operation control, and control over the write operation that the host system 20 according to the embodiment is not concerned with (non-normal write operation). The memory 11 includes a RAM and a ROM besides the flash memory (EEPROM) 110. The memory 11 stores various kinds of data and programs required for control of the CPU 10.

Further, this drive has a temperature sensor 12 used for detecting temperature in the drive. The temperature sensor 12 detects the temperature at fixed sampling intervals, and outputs the temperature value to the CPU 10. The CPU 10 monitors temperature fluctuation in accordance with the detected temperature from the temperature sensor 12.

(Modification)

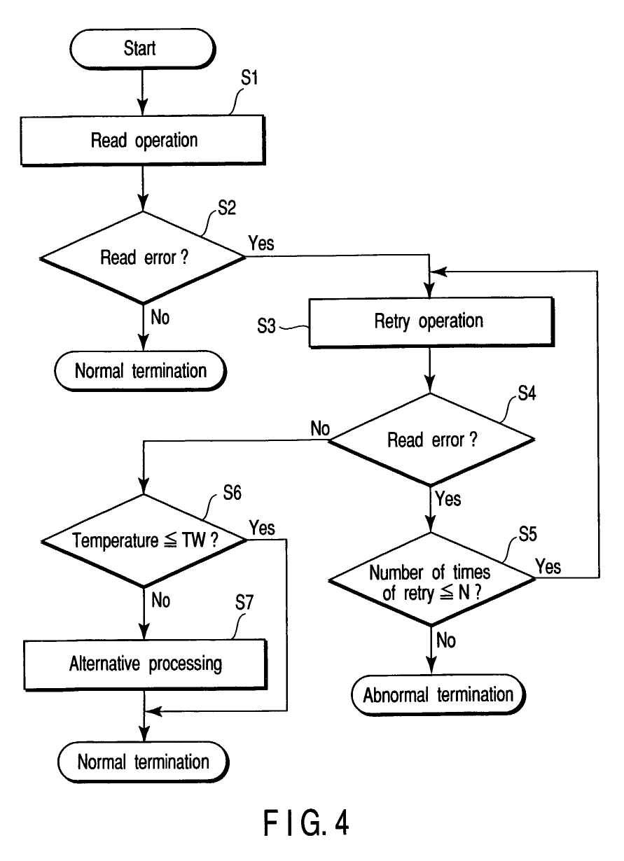

Incidentally, as shown in FIG. 3, the host system 20 can acquire a temperature value detected by the temperature sensor 12 from the disk drive 30 by issuing a predetermined command. Further, the host system 20 may be configured to have its own temperature sensor 200 and monitor changes in the ambient temperature of itself and the drive 30.

(Write operation that Host System is not Concerned With)

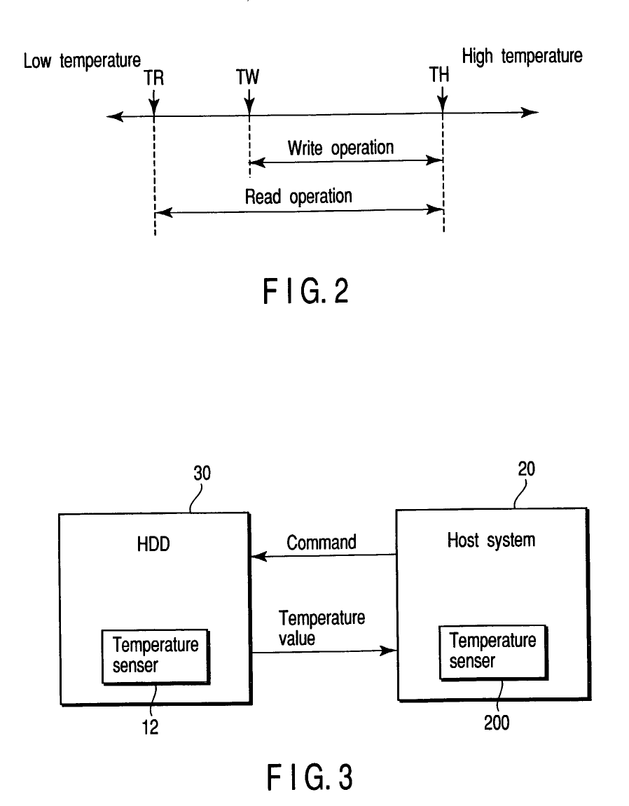

In the first embodiment, as the operating environment of the disk drive, as shown in FIG. 2, a temperature environment in a temperature range enabling operation is assumed. In the temperature range, a high-temperature limit value (TH) is, e.g., approximately 55 degrees Celsius and is set according to the read/write operation characteristic as well as the temperature characteristics of the components of the drive. On the other hand, the low-temperature limit value varies depending on the read operation characteristic and the write operation characteristic. Where, the low-temperature limit value (TW) in the write operation is, e.g., approximately 0 degrees Celsius and is according to the low-temperature characteristic of magnetic recording. Further, the low-temperature limit value (TR) in the read operation is, e.g., approximately −20 degrees Celsius, and the tolerance is relatively wide.

On the other hand, the disk drive executes the write operation that the host system 20 is not concerned with (non-normal write operation irrelevant to issue of the write command) other than the normal write operation according to the write command from the host system 20.

As the non-normal write operation that the host system 20 is not concerned with, specifically, there are assumed the write operation involved in the alternative processing generated in a normal read operation and the write operation for recording history information concerning the operation history of the drive on the disk 1.

The non-normal write operation involved in the alternative processing is, as described above, the operation involved in the alternative processing which changes a recording area (data track or data sector) on the disk where a read error occurred to another recording area. In the alternative processing, there is executed the write operation which rewrites the address conversion table recorded on the disk.

(Alternative Processing in Read Operation)

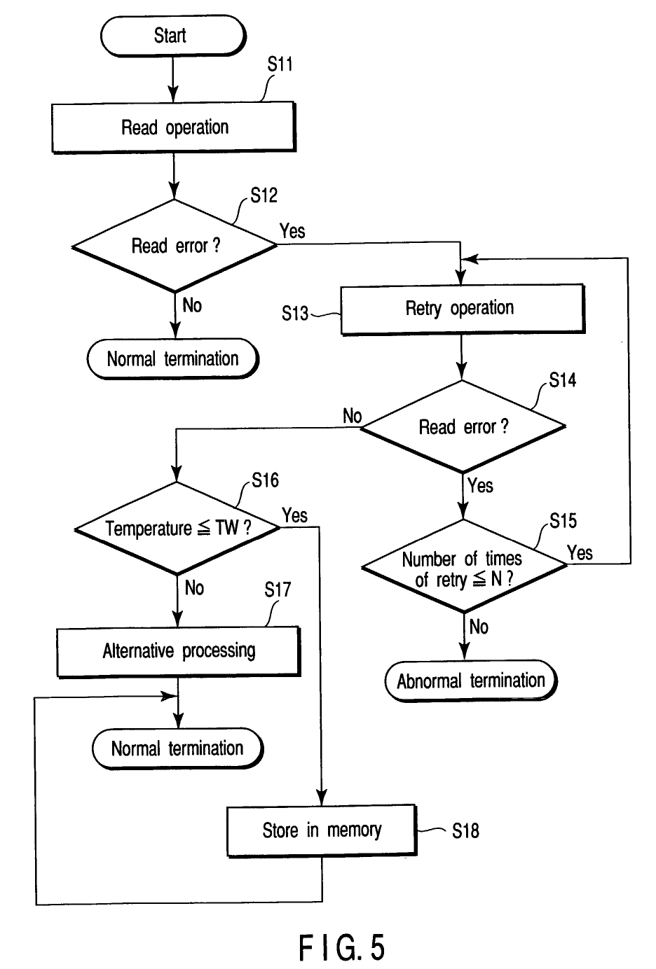

The method for controlling the write operation involved in the alternative processing will now be described with reference to the flowchart of FIG. 4.

The CPU 10 controls positioning of the read head to a target position on the disk 1 in accordance with a read command from the host system 20, and executes the read operation to read data from the target position (step S1). In the read operation, the read signal output from the read head is reproduced to the original recorded data in the R/W channel 8 and transferred to the HDC 9. In the HDC 9, whether a read error is included in the data reproduced by the read operation is checked by ECC (error check/correction) processing. If there is not read error, the read operation is normally terminated (NO at step S2).

On the other hand, when a read error occurs, the CPU 10 executes the retry operation including error correction processing by ECC processing (YES at step S2 and step S3). The CPU 10 repeats the retry operation until the data is reproduced into normal data (read error is eliminated). However, when the number of times of retrying becomes equal to or greater than a predetermined number of times (N), the CPU 10 determines that restoration of the data is impossible and advances to predetermined error processing (NO at step 5S).

When the data is restored to normal data by the retry operation within a predetermined number of times (N), the CPU 10 executes re-allocation processing of data on the disk 1 which is called alternative processing (step S7). It is to be noted that the alternative processing is also called re-assign processing or re-allocation processing.

Meanwhile, when a read error occurs, there is a possibility that the read position on the disk 1 may be defective or damaged. Therefore, the reliability of the recorded data is increased by moving the recorded data to an area with higher reliability (physically different recorded area) by the alternative processing. In this case, an alternative area specified by the alternative processing is an alternative track in case of a track unit, or an alternative sector in case of a data sector unit.

In addition, in the alternative processing, since the recording area on the disk 1 is changed, the file allocation table (FAT) which manages addresses on the disk 1 must be updated. The file allocation table is usually stored in a system area (reference numeral 100 in FIG. 1) which is an outermost track (track 0) on the disk 1.

In short, even though only the read command is issued from the host system 20, the write operation involved in the alternative processing (movement of the user data and updating of the file allocation table) is executed in the disk drive. This write operation is the non-normal write operation that the host system 20 is not concerned with. At this moment, the CPU 10 makes judgment upon whether a temperature value is equal to or less than the low-temperature limit value (TW) in the write operation shown in FIG. 2 based on the temperature detection value from the temperature sensor 12 (step S6).

If the temperature value is higher than the low-temperature limit value (TW), the CPU 10 executes the alternative processing and normally terminates the read operation (NO at step S6 and step S7). On the other hand, when the temperature value is a low temperature not more than the low-temperature limit value (TW), the CPU 10 normally terminates the read operation without executing the alternative processing (YES at step S6). In other words, the CPU 10 inhibits the write operation involved in the alternative processing and disables the alternative processing.

As described above, according to this embodiment, the non-normal write operation is inhibited in the temperature environment which is not more than the low-temperature limit value that depends on the magnetic recording characteristic in the write operation involved in the alternative processing irrelevant to the write command from the host system 20. Therefore, data recording such as moving user data or updating the address management table involved in the alternative processing is not executed. Therefore, it is possible to prevent the data whose reliability is lowered with a low temperature from being recorded on the disk 1 when the host system 20 does not concern.

(Modification)

FIG. 5 is a flowchart showing a modification concerning the control of the write operation involved in the alternative processing (non-normal write operation) of the first embodiment.

This modification makes judgment upon whether the temperature value is not more than the low-temperature limit value (TW) in the write operation shown in FIG. 2 based on the temperature detection value from the temperature sensor 12 (step S16). If the temperature value is higher than the low-temperature limit value (TW), the CPU 10 executes the alternative processing and normally terminates the read operation (NO at step S16 and step S17).

On the other hand, the temperature value is not more than the low-temperature limit value (TW), the CPU 10 normally terminates the read operation without executing the alternative processing (YES at step S16). At this moment, the CPU 10 temporarily stores the recorded data (data concerning movement of the user data and updating of the file allocation table) in the flash memory 110 and normally terminates the processing (step S18).

With such processing, not just the alternatively processing is disabled, but it is temporarily held, and the alternatively processing can be performed in accordance with occasions. That is, the write operation is enabled, and the alternative processing can be executed by utilizing the idle time other than the usual read/write operation. In general, even if an external temperature suddenly drops, the internal temperature of the disk drive increases to some degrees by self-heating when energization continues for a fixed time. Further, in case of the disk drive for a digital device mounted in a car or the like, it can be expected that the ambient temperature environment is changed and an external temperature is increased.

In the embodiment, the CPU 10 can advance to preparation for the alternative processing which uses the data stored in the flash memory 110 when the temperature value from the temperature sensor 12 becomes higher than the low temperature limit value. The CPU 10 executes the alternative processing by using the idle time other than the normal read/write operation and eliminates the data stored in the flash memory 110 after completion of the processing. Therefore, in this embodiment, it is possible to prevent the data whose reliability is lowered due to a low temperature from being recorded, and the recorded data required in the alternative processing can be assured.

It is to be noted that since the processing from step S11 to step S15 in FIG. 5 is similar to that from step S1 to step S5 shown in FIG. 4, the explanation will be omitted.

(Recording Processing of History Information)

Description will now be given as to the method for controlling the write operation involved in the recording processing of the history information concerning the operation history of the drive.

In the disk drive, the write operation (updating operation) for recording the history information concerning the operation history of the drive in a system area (area 100 of track 0) on the disk 1 is executed at the start-up immediately after turning on the power supply or in the idle time other than the normal read/write operation. This write operation is the non-normal write operation that the host system 20 is not concerned with.

The history information is the information concerning use of the drive such as a number of times of the alternative processing or information specified by a predetermined standard (for example, SMART standard) such as a number of times of irregular stops.

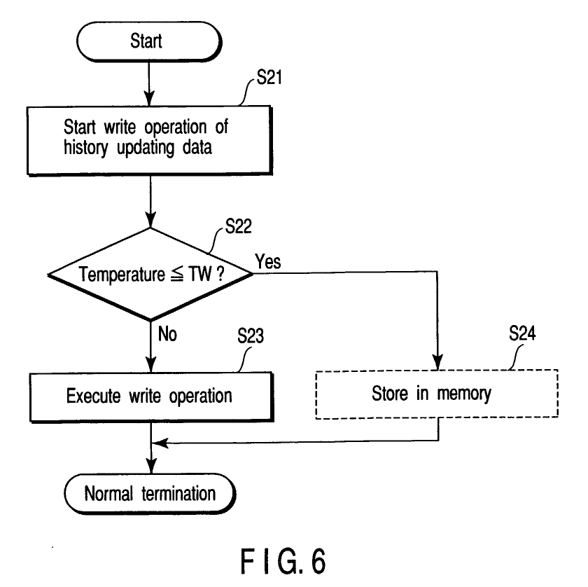

The CPU 10, as shown in FIG. 6, starts the write operation of the updating data concerning updating of the history information at the time of start-up immediately after turning on the power supply or in the idle time other than the normal read/write operation (step S21). At this moment, the CPU 10 makes judgment upon whether a temperature value is not more than the low-temperature limit value (TW) in the write operation shown in FIG. 2 based on the temperature detection value from the temperature sensor 12 (step S22).

If the temperature value is higher than the low-temperature limit value (TW), the CPU 10 updates the history information by executing the write operation and normally terminates the processing (NO at step S22 and step S23). On the other hand, the temperature value is lower than the low-temperature limit value (TW), the CPU 10 normally terminates the processing without executing the write operation (YES at step S22). Here, the CPU 10 can temporarily save the updating data concerning updating of the history information in the flash memory 110 (step S24).

As described above, in the write operation mode involved in the recording (updating) processing of the history information irrelevant to the write command from the host system 20, the write operation is inhibited in the temperature environment equal to or lower than the low-temperature limit value (TW) depending on the magnetic recording characteristic. Therefore, when the host system 20 does not concern, it is possible to prevent the data whose reliability is lowered with a low temperature from being recorded on the disk 1.

The write operation can be restarted when the temperature environment is improved for the reason above-mentioned by temporarily storing the updating data concerning updating of the history information into the flash memory 110.

Incidentally, in this embodiment, as the write operation mode that the host system 20 is not concerned with, the write operation involved in the alternative processing and recording processing (updating processing) of the history information is assumed. However, the present invention is not restricted thereto, all the write operations for automatically recording data on the disk 1 by judgment of the drive itself are included.

Further, the temperature sensor 12 may be installed on any of a circuit board attached to the outside of the disk drive and a circuit board arranged in the drive. Furthermore, as shown in FIG. 3, it may be a structure that the CPU 10 makes judgment upon the temperature situation in the drive by utilizing the temperature detection value from the temperature sensor 200 provided in the host system 20.

To sum up, when the temperature state in the disk drive is changed to the low-temperature limit or below, the write operation that the host system is not concerned with (non-normal write operation) can be automatically inhibited. Therefore, in the temperature environment equal to or lower than a low-temperature limit, data recording involved in the alternative processing in the normal read operation or data recording of the history information executed at the startup of the apparatus is inhibited, for example. As a result, data recording with the low reliability can be avoided, and hence the sufficient reliability can be thereby assured with respect to data recording that the host system is not concerned with the disk.

As for the normal read/write operation that the host system is concerned with, the host system executes the processing to inhibit the read/write operation in the temperature environment equal to or below the low-temperature limit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

(Second embodiment)

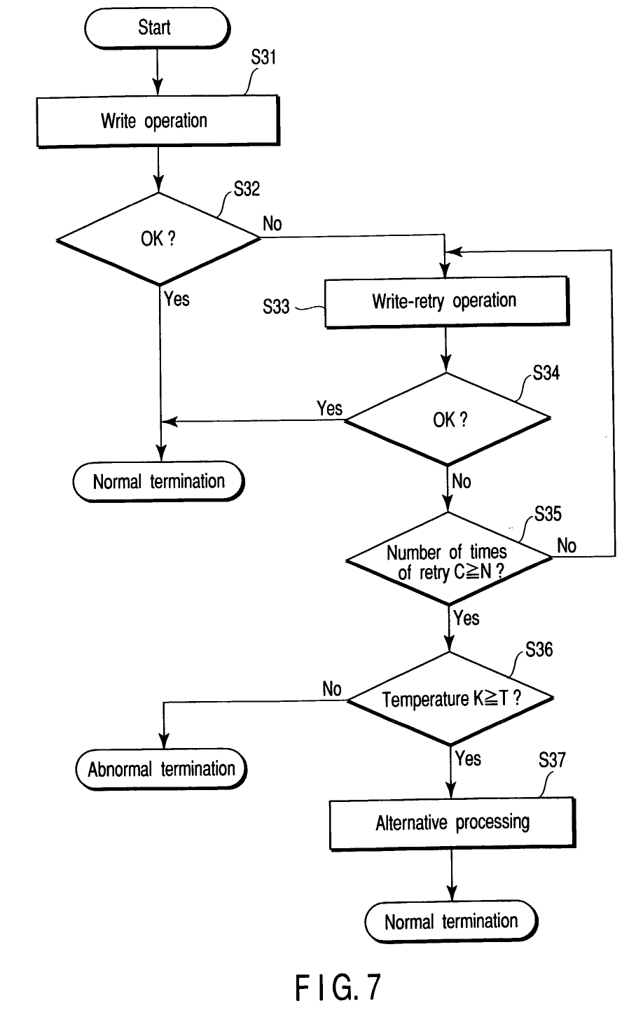

A second embodiment will now be described with reference to a flowchart of FIG. 7.

Here, a temperature detection value of the temperature sensor 12 is denoted as “K”, and a low-temperature limit value with which the regular read/write operation can be normally executed is designated as a stipulated value T. If an ambient temperature (K) of the drive is not less than the stipulated value T, the CPU 10 determines that a normal temperature environment is provided. Usually, the temperature sensor 12 is mounted on a circuit substrate provided to the disk drive.

It is to be noted that the host system 20 may be configured to have its own temperature sensor, monitor a change in ambient temperature of itself and the drive, and informs the CPU 10 of the temperature detection value K through the HDC 9. Furthermore, by issuing a predetermined command, the host system 20 can acquire the temperature value K detected by the temperature sensor 12 from the disk drive.

Here, it is assumed that the disk drive receives a write command from the host system 20. Upon receiving the write command, the CPU 10 positions the head 2 in a specified area on the disk 1, and executes the write operation to write data transmitted from the host system 20 (step S31).

In the write operation, the CPU 10 confirms the positioning accuracy of the head 2 with respect to the specified area on the disk 1. When the positioning accuracy is sufficient, the CPU 10 determines that the normal write operation is possible, and executes the write operation of the data (write OK, YES at a step S32). The positioning accuracy of the head 2 fluctuates by the state of servo information previously recorded on the disk 1, an influence of disturbance (acceleration) applied to the drive, or the like. When the CPU 10 confirms that the normal write operation is possible on the disk 1, it executes the write operation and informs the host system 20 of normal termination (YES at the step S32).

On the other hand, when the CPU 10 can not confirm the sufficient head positioning accuracy, namely, can not confirm that the normal write operation is possible, it repeats a write retry operation within a predetermined number of times (N) (NO at the step S32, and S33 to S35). Based on this write retry operation, when write OK can be confirmed, the CPU 10 informs the host system 20 of normal termination of the normal write operation (YES at a step S34).

On the other hand, when the above-described condition can not be confirmed even if the write retry operation exceeds a predetermined number of times and the normal write operation (actually, the sufficient head positioning accuracy) can not be confirmed, the CPU 10 stops the write operation (YES at a step S35).

In this state, the CPU 10 makes judgment upon whether a temperature of the drive (an ambient temperature or an internal temperature) is in the low-temperature state less than the stipulated value T based on a result of comparison between the temperature detection value K from the temperature sensor 12 and the stipulated value T (step S36). If a temperature of the drive is not less than the stipulated value T and normal, the CPU 10 advances to alternative processing (YES at the step S36, and S37).

In the alternative processing, the CPU 10 disables a specified area (write target area) in which the write operation is impossible), sets a predetermined alternative area on the disk 1, and changes the specified area. This alternative area is an alternative track in units of track, or an alternative sector in units of data sector. Here, the CPU 10 executes processing to rewrite (update) address management table information (or FAT: file allocation table) recorded on, e.g., an outermost track 100 on the disk 1 as alternative processing information. Based on this alternative processing, the CPU 10 executes the write operation to record data in the alternative area, and informs the host system 20 of normal termination.

On the other hand, when the CPU 10 confirms that a temperature of the drive is in the low-temperature state less than the stipulated value T, it inhibits the alternative processing and advances to predetermined abnormal processing (NO at the step S36). The predetermined abnormal processing includes processing to inform the host system 20 that the CPU 10 can not normally execute the write command, and others.

As described above, according to the method of the second embodiment, when the normal write operation can not be confirmed based on the positioning accuracy of the head 2, the drive automatically executes the alternative processing if a temperature of the drive falls within an allowable range. On the other hand, when a temperature of the drive is low, i.e., less than the stipulated value T, the alternative processing is inhibited.

In the low-temperature state, the write capability of the write head relatively lowers, and the reliability of data recording when executing the write operation is decreased. Thus, since the method according to this embodiment does not execute the rewrite operation (write operation) of the alternative processing information involved by the alternative processing by inhibiting the alternative processing, it is possible to avoid a situation such that the alternative processing information with the low reliability is recorded on the disk 1. Since the host system 20 can confirm that write operation is impossible based on notification from the drive, it can reissue the write command.

(Third embodiment)

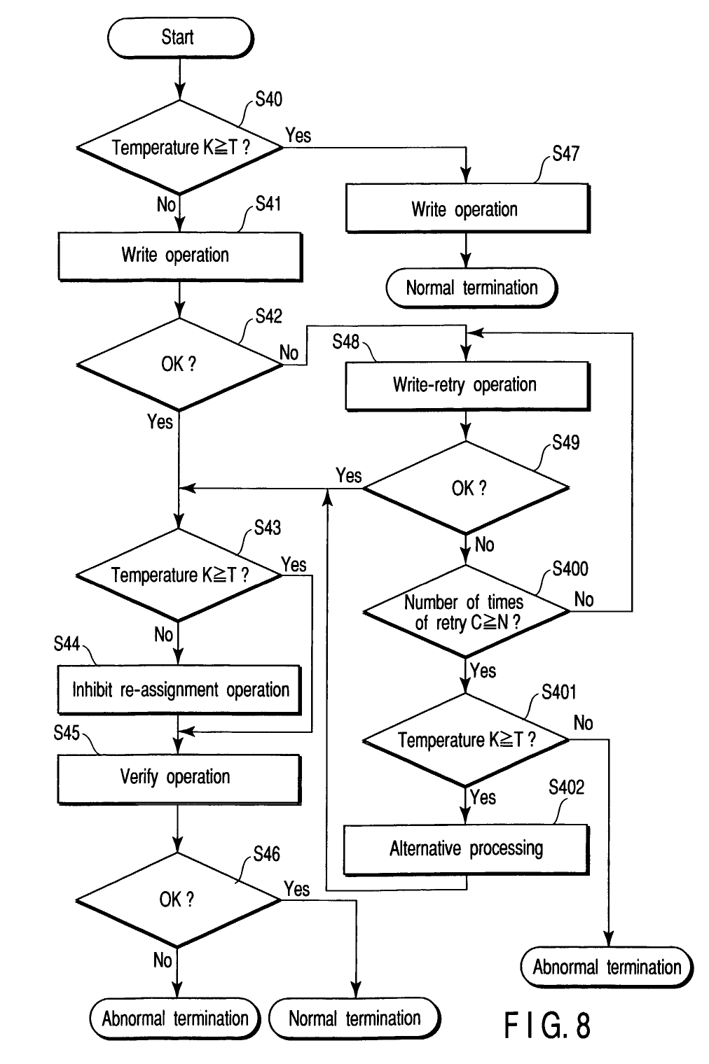

A third embodiment will now be described with reference to a flowchart of FIG. 8.

This embodiment normally terminates the write operation if normal recording can be confirmed by reading and verifying data recorded by the write operation when a temperature of the drive is low, i.e., less than the stipulated value T at the time of executing the write operation such as a test write operation.

In response to a write command (for example, a test write command) from the host system 20, the CPU 10 executes the write operation with respect to a specified area on the disk 1. At this moment, when a temperature of the drive is normal, i.e., not less than the stipulated value T, the CPU 10 executes the regular write operation (including the regular alternative processing). Moreover, when the operation is normally terminated, the CPU 10 informs the host system 20 of normal termination (YES at a step S40, and S47).

On the other hand, when a temperature of the drive (detection value K) is in the low-temperature state less than the stipulated value T, the CPU 10 makes judgment upon whether write OK is obtained based on the positioning accuracy of the head 2 (steps S41 and S42), and executes the data write operation if it is determined that the write operation can be executed (write OK, YES at the step S42). Here, when write OK can not be determined, as similar to the second embodiment mentioned above, the CPU 10 executes the control over the write retry processing and the alternative processing (including inhibition) (NO at the step S42, and S48 and S49 to S402).

On the other hand, when write OK is determined, the CPU 10 performs the verify operation to read and check data recorded by the write operation from the disk 1 (YES at the step S42, and S45). When normal recording can be confirmed based on this verify operation, the CPU 10 informs the host system 2 of normal termination of the write operation (YES at a step S46). On the other hand, when normal recording can not be confirmed, predetermined abnormal processing such as processing to inform the host system 2 that the CPU 10 can not normally execute the write operation is conducted (NO at the step S46).

Here, the CPU 10 confirms whether a temperature of the drive has risen to the stipulated value T before executing the verify operation (step S43). When this temperature is not changed from the low-temperature state, the CPU 10 inhibits read reassign processing (NO at the step S43, and S44). The read reassign processing is alternative processing involved by the read operation. That is, when a read error is generated at the time of execution of the read operation, the read retry processing is repeated for a predetermined number of times. When the read error can be restored by this read retry processing, the read reassign processing is automatically executed.

Thus, in this embodiment, when a temperature of the drive is low, i.e., less than the stipulated value T, it is possible to inhibit the write operation of the alternative processing information involved by the alternative processing by prohibiting the read assign processing in advance. It is, therefore, possible to avoid a situation such that the alternative processing information with the low reliability is recorded on the disk 1.

(Fourth embodiment)

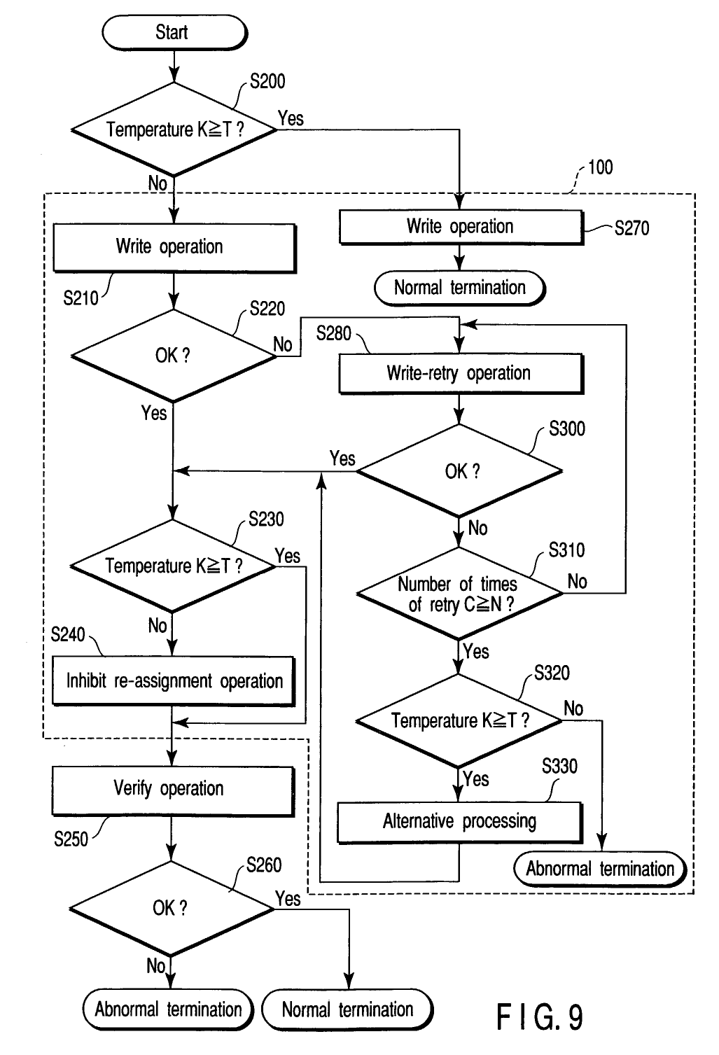

A fourth embodiment will now be described with reference to a flowchart of FIG. 9.

In this embodiment, the host system 20 monitors an ambient temperature of the drive (or the system) by using a temperature sensor 12 mounted on the disk drive or a temperature sensor mounted on the system itself. In addition, this is the method to execute the verify operation for confirming the write operation conducted in the low-temperature state in the second embodiment mentioned above in response to a command from the host system 20.

That is, when a write command is issued, the host system 20 confirms whether an ambient temperature of the drive (or the system) is in the low-temperature state, i.e., less than the stipulated value T (step S200). In the disk drive, the CPU 10 confirms whether the ambient temperature of the drive is in the low-temperature state less than the stipulated value T based on notification from the temperature sensor 12 or the drive or the host system 20. Additionally, as similar to the second embodiment, the CPU 10 automatically executes a series of processing (range of reference numeral 100) in accordance with the write command from the host system 20 (steps S210 to S240, S270, S280 and S300 to S330).

On the other hand, in cases where the ambient temperature of the drive is in the low-temperature state less than the stipulated value T, when the drive confirms write OK in the write operation, the host system 20 executes the verify operation to read and check data recorded by the write operation from the disk 1 (step S250). When normal recording is confirmed, the host system 20 confirms that the write operation is normally terminated based on notification from the CPU 10 (YES at the step S260). On the other hand, when normal recording can not be confirmed, the host system 20 confirms that the write operation is not normal but abnormally terminated based on notification from the CPU 10 (NO at the step S260).

(Fifth embodiment)

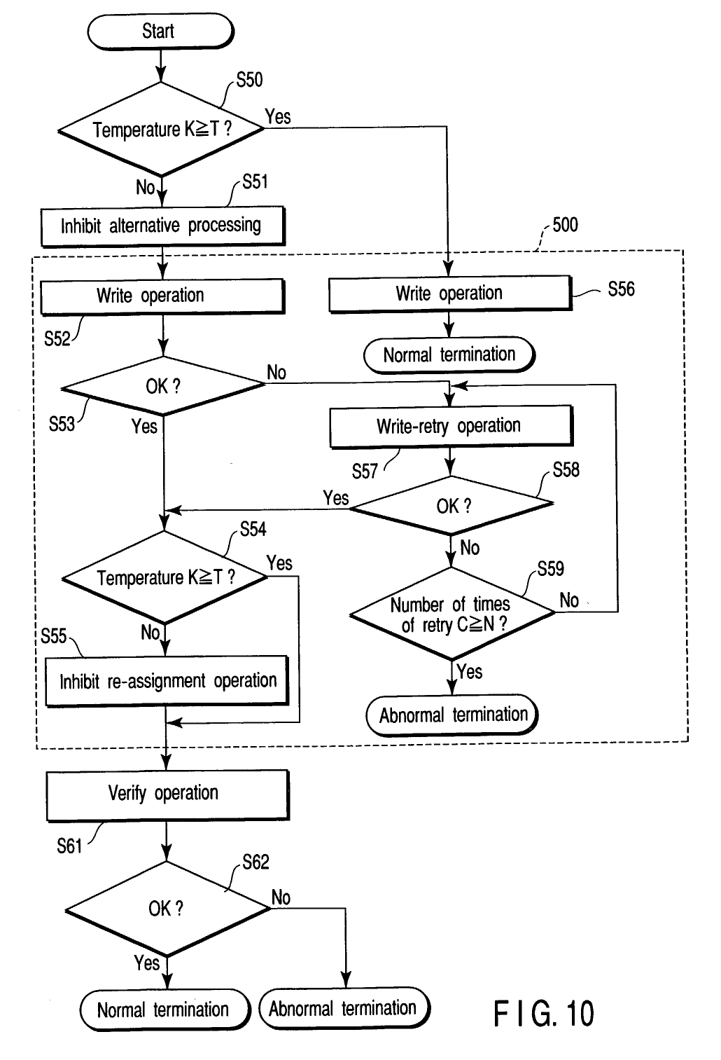

A fifth embodiment will now be described with reference to a flowchart of FIG. 10.

In this embodiment, the host system 20 monitors an ambient temperature of the drive (or the system) by using a temperature sensor 12 mounted on the disk drive or a temperature sensor mounted on the system itself (step S50). Additionally, when the ambient temperature of the drive is in the low-temperature state less than the stipulated value T, the host system 20 issues a command to inhibit the alternative processing to the disk drive (step S51). It is to be noted that the range denoted by reference numeral 500 in FIG. 5 indicates processing which is automatically executed by the disk drive.

In response to a write command from the host system 20, the CPU 10 executes the write operation with respect to a specified area on the disk 1. At this moment, when the ambient temperature of the drive is normal not less than the stipulated value T, the CPU 10 executes the regular write operation (including the regular alternative processing). Further, when the operation is normally terminated, the CPU 10 informs the host system 20 of normal termination (YES at a step S50, and S56).

On the other hand, when the ambient temperature (detection value K) of the drive is in the low-temperature state less than the stipulated value, the CPU 10 receives a command to inhibit the alternative processing as well as the write command (steps S51 and S52). The CPU 10 confirms whether write OK indicative of the normal write operation is obtained based on the positioning accuracy of the head 2 (step S53). Here, when write OK can not be confirmed, the CPU 10 executes the write retry processing only for a predetermined number of times (N) (NO at the step S53, and S57 to S59). However, since the command to inhibit the alternative processing is received, the CPU 10 advances to predetermined abnormal processing without executing the alternative processing when the write retry processing is conducted for the predetermined number of times (N) (YES at a step S59).

Incidentally, when write OK is confirmed, the CPU 10 proceeds to the verify processing based on a command from the host system 20 as similar to the third embodiment mentioned above (YES at the step S53, and S61 and S62). It is to be noted that the CPU 10 automatically executes the read reassign inhibition processing (NO at the step S54, and S55).

(Sixth embodiment)

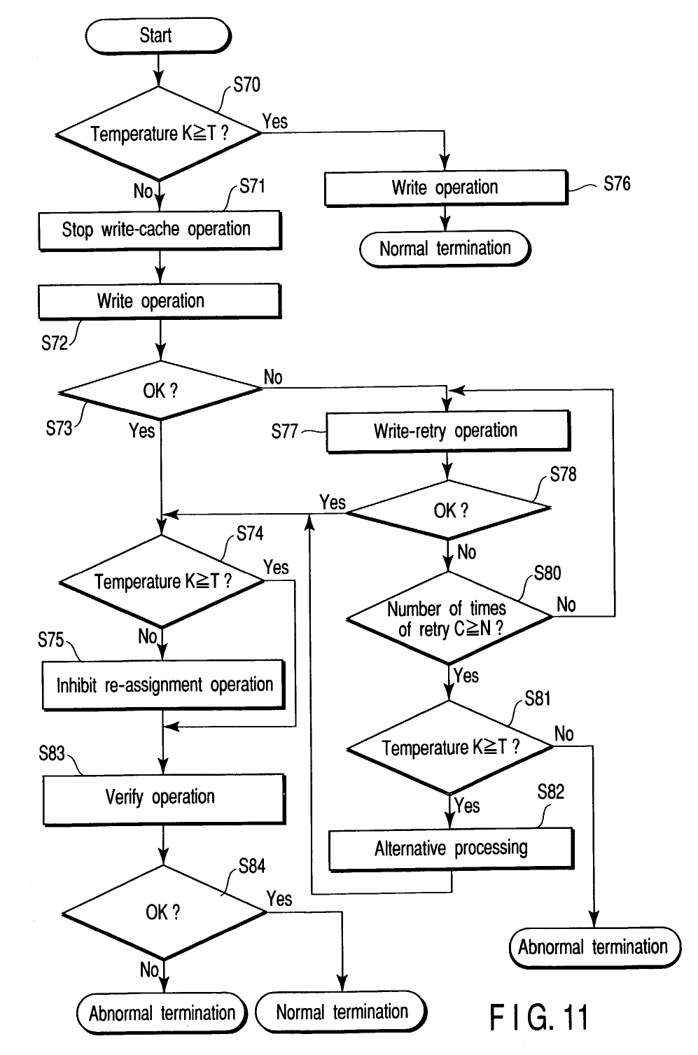

A sixth embodiment will now be described with reference to a flowchart of FIG. 11.

This embodiment is a method to stop a write cache function executed by the HDC 9 using the buffer memory 90 when a temperature of the drive is in the low-temperature state less than the stipulated value T.

That is, in response to a write command (for example, a test write command) from the host system 20, the CPU 10 executes the write operation with respect to a specified area on the disk 1. At this moment, when the temperature of the drive is normal, namely, it is not less than the stipulated value T, the CPU 10 executes the regular write operation (including the regular alternative processing). Furthermore, when the operation is normally terminated, the CPU 10 informs the host system 20 of the normal termination (YES at a step S70, and S76).

On the other hand, when a temperature (detection value K) of the drive is in the low temperature state less than the stipulated value T, the CPU 10 stops is the write cache function of the HDC 9 (NO at the step S70, and S71). Then, the CPU 10 confirms write OK indicative of the normal write operation based on the positioning accuracy of the head 2 (steps S72 and S73). Incidentally, the processing of the steps S74, S75, S77, S78 and S80 to S84 is similar to the processing of the steps S23 to S26, S28 and S30 to S33 in the second embodiment (see FIG. 3), thereby omitting the explanation.

Here, the HDC 9 of the disk drive has the write cache function to store the write data in the buffer memory 90 when the write data is transferred from the host system 20 in order to improve a data transfer speed. In the disk drive having the write cache function, if the read command is issued after executing the write operation when the temperature is low, the verify operation is carried out, and the data write-cached in the buffer memory 90 is transferred to the host system 20. Therefore, the data actually recorded on the disk 1 may not be possibly transferred to the host system 20.

Thus, in this embodiment, when the write cache function is provided, the write cache function is stopped before executing the write operation when the temperature of the drive is in the low-temperature state. Alternatively, the CPU 10 may execute the write operation or the read operation of the data after clearing (flashing) the data stored in the buffer memory 90.

In brief, according to the method of this embodiment, since the write cache function is stopped when the temperature of the drive is in the low-temperature state in particular, the data actually recorded on the disk 1 can be transferred to the host system 20 in place of the data subjected to write cache in case of reading the data immediately after being recorded by the write operation. As a result, the host system 20 can confirms the data actually recorded on the disk 1 when the temperature of the drive is in the low-temperature state.

(Seventh embodiment)

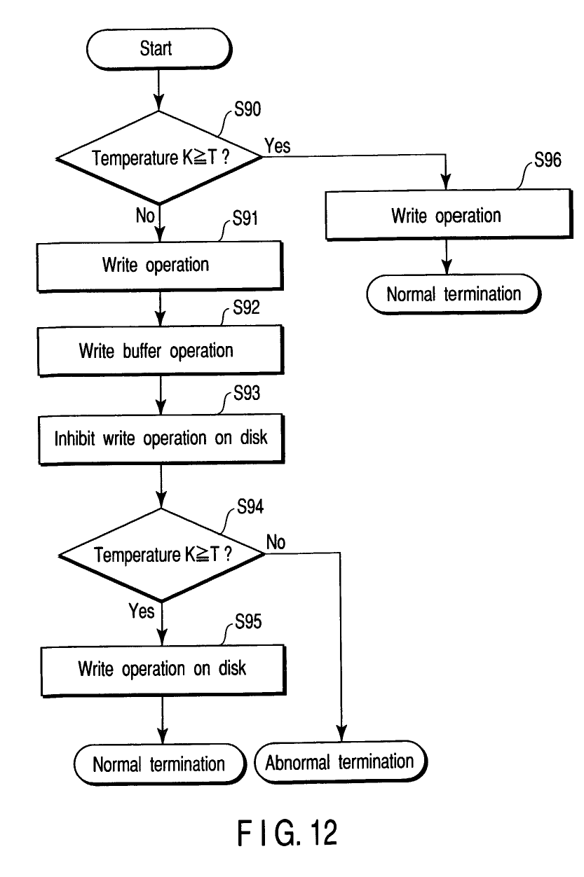

A seventh embodiment will now be described with reference to a flowchart of FIG. 12.

This embodiment is a method which buffers the write data to the buffer memory 90 and temporarily inhibits the write operation to the disk 1 when an ambient temperature of the drive is in the low-temperature state less than the stipulated value T. This method will now be concretely described hereinafter.

In response to a write command from the host system 20, the CPU 10 starts the write operation with respect to a specified area on the disk 1. At this moment, when the temperature of the drive is normal, i.e., it is not less than the stipulated value T, the CPU 10 executes the regular write operation (including the regular alternative processing). Furthermore, when the operation is normally terminated, the CPU 10 informs the host system 20 of normal termination (YES at a step S90, and S96).

On the other hand, when the temperature of the drive is in the low-temperature state less than the stipulated value T, the CPU 10 temporarily stores the write data transferred from the host system 20 into the buffer memory 90, and temporarily inhibits the write operation (disk write) to the disk 1 (steps S91 to S93).

Then, after elapse of a predetermined time, when the temperature of the drive rises to the stipulated value T, the CPU 10 cancels inhibition of disk write, and records the data stored in the buffer memory 90 onto the disk 1 (YES at a step S94, and S95). When the temperature of the drive remains in the low-temperature state even if a predetermined time has passed, the CPU 10 executes predetermined abnormal processing such as processing to inform the host system 20 that the write command can not be normally executed (NO at the step S94).

As described above, according to the method of this embodiment, when the temperature of the drive (the ambient temperature or the internal temperature) is in the low-temperature state, the write operation to the disk 1 is temporarily suspended, and the write data is buffered until the normal temperature state is obtained. It is, therefore, possible to avoid a situation such that the write data with the low reliability is recorded.

As to the temperature of the drive, since heat is generated in the drive when the power supply is turned on, increase in temperature can be expected when a given time passes. Thus, by temporarily buffering the write data until elapse of a predetermined time, it is possible to relatively avoid the situation that the write operation is disabled.

Incidentally, in each of the foregoing embodiments, when an attachment position of the temperature sensor 12 in the drive is distanced from positions of disk 1 and the head 2, a difference in temperature may be possibly produced between them. In such a case, it is desirable to obtain the correlation of temperature between the both positions in advance and determine the stipulated value T based on this correlation.

What is claimed is:

1. A disk drive comprising:
a read/write mechanism for executing a read operation and a write operation of data with respect to a magnetic disk medium;
a temperature sensor which detects a temperature; and
a controller which inhibits a non-normal write operation when a temperature value detected by said temperature sensor is not more than a stipulated value in said non-normal write operation in which data is written on said magnetic disk medium by said read/write mechanism irrespective of a write command from the outside.

2. A disk drive according to claim 1, wherein said non-normal write operation includes a write operation in alternative processing involved in generation of a read error when executing said read operation according to a read command from the outside.

3. A disk drive according to claim 1, wherein said non-normal write operation includes a write operation for recording predetermined information in a predetermined area on said magnetic disk medium in a period excluding a period of executing a normal read operation or write operation.

4. A disk drive according to claim 1, further comprising:
a memory which temporarily stores data to be recorded on said magnetic disk,
wherein said controller inhibits said non-normal write operation when said temperature value is not more than a stipulated value and temporarily stores data to be recorded on said magnetic disk medium.

5. A disk drive according to claim 1, further comprising:
a memory which temporarily stores data to be recorded on said magnetic disk medium,
wherein said non-normal write operation includes a write operation in alternative processing involved in generation of a read error when executing a read operation according to a read command from the outside, and
said controller inhibits said alternative processing which involves said write operation when said temperature value is not more than a stipulated value and temporarily stores data to be recorded on said magnetic disk medium.

6. A disk drive according to claim 1, further comprising:
a memory which temporarily stores data to be recorded on said magnetic disk medium,
wherein said non-normal write operation includes a write operation for recording predetermined information in a predetermined area on said magnetic disk medium in a period excluding a period of executing a normal read operation or write operation, and
said controller inhibits said write operation when said temperature value is not more than a stipulated value and temporarily stores in said memory predetermined information to be recorded in a predetermined area on said magnetic disk medium.

7. A disk drive according to claim 1, wherein said non-normal write operation includes a write operation which records or updates information concerning an operation history of said drive in a predetermined area on said magnetic disk medium at the time of start-up of said disk drive.

8. A method of controlling write operation for a disk drive which includes a magnetic disk medium and a temperature sensor, the method comprising:
acquiring a temperature value detected by said temperature sensor in a non-normal write operation to record data on said magnetic disk medium irrelevant to a write command from the outside; and
inhibiting said non-normal write operation when said temperature value is not more than a stipulated value.

9. A method according to claim 8, wherein said non-normal write operation includes a write operation in alternative processing involved in generation of a read error when executing a read operation according to a read command from the outside.

10. A method according to claim 8, wherein said non-normal write operation includes a write operation to record predetermined information in a predetermined area on said magnetic disk medium in a period excluding a period of executing a normal read operation or write operation.

11. A method according to claim 8, wherein said non-normal write operation includes a write operation to record or update information concerning an operation history of said drive in a predetermined area on said magnetic disk medium at start-up of said disk drive.

12. A method according to claim 8, further comprising:
temporarily storing data to be recorded on said magnetic disk medium after inhibiting said non-normal write operation.

13. A method according to claim 9, further comprising:
temporarily storing data to be recorded on said magnetic medium involved in said alternative processing after inhibiting said non-normal write operation.

14. A method according to claim 10, further comprising:
temporarily storing said predetermined information to be recorded on said magnetic disk medium after inhibiting said non-normal write operation.

15. A method according to claim 11, further comprising:
temporarily storing information concerning an operation history of said disk drive after inhibiting said non-normal write operation.

16. A disk storage apparatus comprising:
read/write means for executing a read operation or a write operation of data with respect to a disk medium by using a head;
a temperature sensor which detects a temperature;
means for executing alternative processing to change a write target area on said disk medium to an alternative area if it is determined that a normal write operation is impossible when executing said write operation; and
controlling means for inhibiting said alternative processing when a temperature detected by said temperature sensor is lower than a stipulated value.

17. The disk storage apparatus according to claim 16, wherein said alternative processing includes a rewrite operation of alternative processing information to change a write target area on said disk medium to an alternative area.

18. The disk storage apparatus according to claim 17, wherein said alternative processing information corresponds to address management table information or file allocation table information recorded on said disk medium.

19. The disk storage apparatus according to claim 16, wherein said controlling means determines that a normal write operation is impossible and executes a write retry operation for a predetermined number of times when said head can not be positioned in a write target area on said disk medium at the time of said write operation, and
controls so as to allow execution of said alternative processing when a temperature detected by said temperature sensor rises to a stipulated value.

20. The disk storage apparatus according to claim 16, wherein said controlling means determines that a normal write operation is impossible and executes a write retry operation for a predetermined number of times when said head can not be positioned in a write target area on said disk medium at the time of said write operation, and
inhibits said alternative processing and controls so as to execute predetermined error processing when a temperature detected by said temperature sensor is lower than a stipulated value.

21. The disk storage apparatus according to claim 16, wherein said controlling means reads and verifies data recorded by said write operation from a specified area if a temperature detected by said temperature sensor is lower than a stipulated temperature when said write operation is executed in said specified area on said disk medium in accordance with a write command from the outside, and
normally terminates when recording normality is confirmed by said verify operation, and controls so as to execute predetermined error processing when recording normality is not confirmed.

22. The disk storage apparatus according to claim 16, wherein said controlling means executes said write operation in a specified area on said disk medium in accordance with a write command from the outside, and
controls so as to inhibit alternative processing involved by said read retry operation if a temperature detected by said temperature sensor is lower than a stipulated value when reading data recorded by said write operation from said specified area in accordance with a read command from the outside.

23. A disk storage apparatus which execute a read/write operation of data with respect to a disk medium by using a head in accordance with a read/write command from a host system having a temperature detection function to detect a temperature, said apparatus comprising:
means for executing alternative processing to change a write target area on said disk medium to an alternative area if it is determined that a normal write operation is impossible when executing a write operation; and
controlling means for inhibiting said alternative processing when said host system informs that a temperature is lower than a stipulated value.

24. The disk storage apparatus according to claim 23, wherein said controlling means executes a write operation in a specified area on said disk medium in accordance with a write command from said host system,
reads and verifies data recorded by said write operation from said specified area in accordance with a command from said host system when a temperature is lower than a stipulated value, and
normally terminates when recording normality is confirmed by said verify operation, and controls so as to execute predetermined error processing when recording normality is not confirmed.

25. The disk storage apparatus according to claim 23, wherein said controlling means controls so as to inhibit said alternative processing in accordance with a command from said host system when a temperature is lower than a stipulated value.

26. The disk storage apparatus according to claim 23, wherein said controlling means inhibits said alternative processing,
determines that a normal write operation is impossible and executes a write retry operation for a predetermined number of times if said head can not be positioned in a write target area on said disk medium when executing said write operation in accordance with a write command from said host system, and
controls so as to execute predetermined error processing when said normal write operation is impossible after completion of said write retry operation for a predetermined number of times.

27. The disk storage apparatus according to any of claims 16, wherein said controlling means controls so as to stop a write cache function or clear a write buffer when a temperature detected by said temperature sensor is lower than a stipulated value.

28. The disk storage apparatus according to any of claims 16, wherein said controlling means controls so as to stop a write cache function or clear a write buffer in accordance with notification or a command from said host system when a temperature is lower than a stipulated value.

29. A disk storage apparatus comprising:
read/write means for executing a read operation or a write operation of data with respect to a disk medium by using a head;
a temperature sensor which detects a temperature;
write buffering means for temporarily storing write data in a buffer memory at the time of said write operation; and
controlling means for inhibiting said write operation with respect to said disk medium with said write data being held in said buffer memory at the time of said write operation when a temperature detected by said temperature sensor is lower than a stipulated value.

30. The disk storage apparatus according to claim 29, wherein said controlling means controls so as to cancel write inhibition with respect to said disk medium and write data stored in said buffer memory onto said disk medium when a temperature detected by said temperature sensor rises to a stipulated value.

31. A write controlling method applied to a disk storage medium which records data onto a disk medium by using a head, said method comprising:
a step of detecting a temperature;
a step of confirming whether a normal write operation is possible based on a positioning accuracy when positioning said head in a write target area at the time of executing a write operation on said disk medium;
a step of executing alternative processing to change said write target area on said disk medium to an alternative area when it can not be confirmed that said normal write operation is possible by said confirmation step; and
a step of inhibiting said alternative processing when a temperature obtained at said detection step is lower than a stipulated value.

32. The write controlling method according to claim 31, further comprising: a step of executing a write retry operation for a predetermined number of times when it can not be confirmed that said normal write operation is possible at said confirmation step; and
step of allowing execution of said alternative processing when said temperature rises to a stipulated value.

33. The write controlling method according to claim 31, further comprising: a step of reading and verifying data recorded by said write operation from a specified area if a temperature detected by said detection step is lower than a stipulated value when executing a write operation in said specified area on said disk medium in accordance with a write command from the outside; and
a step of normally terminating when recording normality is confirmed by said verify step and executing predetermined error processing when recording normality is not confirmed by said same step.

34. The write controlling method according to claim 31, wherein said inhibition step inhibits said alternative processing in accordance with a command from the outside when said temperature is lower than a stipulated value.

35. The write controlling method according to claim 31, further comprising a step of stopping a write cache function or clearing a write buffer when a temperature obtained by said detection step is lower than a stipulated value.
